(19) United States
(12) Patent Application Publication
(10) Pub. No.: US 2025/0383301 A1
(43) Pub. Date: Dec. 18, 2025

(54) RADIOGRAPHY CONTROL APPARATUS, RADIOGRAPHIC IMAGING SYSTEM, AND NON-TRANSITORY COMPUTER-READABLE RECORDING MEDIUM

(71) Applicant: Konica Minolta, Inc., Tokyo (JP)

(72) Inventors: Nobuyuki MIYAKE, Kanagawa (JP); Naoki HAYASHI, Tokyo (JP); Atsushi TANEDA, Tokyo (JP); Keisuke KOEDA, Saitama (JP)

(21) Appl. No.: 19/230,398

(22) Filed: Jun. 6, 2025

(30) Foreign Application Priority Data
Jun. 14, 2024 (JP) 2024-096825

(51) Int. Cl. G01N 23/04

(52) U.S. Cl. CPC G01N 23/04; G01N 2223/306

(57) ABSTRACT

The radiography control apparatus includes a hardware processor that controls a radiographic imager in an intermittent imaging mode in which a plurality of times of capturing of a dynamic image by the radiographic imager are allowed during one imaging period from an imaging start to an imaging end. The hardware processor determines the imaging end in the one imaging period based on a predetermined condition.

### CROSS REFERENCE TO RELATED APPLICATIONS

The entire disclosure of Japanese patent Application No. 2024-096825, filed on Jun. 14, 2024, is incorporated herein by reference in its entirety.

### BACKGROUND

### Technological Field

The present invention relates to a radiography control apparatus, a radiographic imaging system, and a non-transitory computer-readable recording medium.

### Description of Related Art

Conventionally, a radiographic image system is known which is intended to capture a radiographic image of a subject in an imaging room or the like in a hospital. For example, Japanese Unexamined Patent Publication No. 2019-5073 discloses a configuration of a medical cart that captures a radiographic image of a subject who is difficult to move to an imaging room, such as a seriously injured person.

### SUMMARY

Incidentally, in the capturing of a radiographic image, the total dose is limited in consideration of the amount of exposure of the subject. In particular, in imaging outside the imaging room, the total dose in one imaging is further limited from the viewpoint of risk management. Under such an environment other than the imaging room, imaging in which radiation irradiation is performed for a relatively long time, such as fluoroscopic imaging, cannot be performed. Due to the above-described problem, for example, when the follow-up observation during the treatment or

the in-vivo situation at the time of the injection of the contrast agent is desired to be imaged and confirmed, it is necessary to move the subject to a fluoroscopic imaging room and perform imaging regardless of the physical condition of the subject, which imposes a large burden on the subject.

An object of the present invention is to provide a radiography control apparatus, a radiographic imaging system, and a non-transitory computer-readable recording medium capable of acquiring a radiographic image of a necessary period by an easy-to-use operation while suppressing an increase in the exposure dose of a subject.

In order to realize at least one of the above-described objects, a radiography control apparatus reflecting one aspect of the present invention is a radiography control apparatus that controls a radiographic imager capable of capturing a radiographic image by irradiation with radiation, the radiography control apparatus including:
a hardware processor that controls the radiographic imager in an intermittent imaging mode in which a plurality of times of capturing of a dynamic image by the radiographic imager are allowed during one imaging period from an imaging start to an imaging end, in which
the hardware processor determines the imaging end in the one imaging period based on a predetermined condition.

In order to realize at least one of the above-described objects, a radiographic imaging system reflecting one aspect of the present invention includes:
a radiographic imager; and
the radiography control apparatus described above.

In order to achieve at least one of the above-described objects, a non-transitory computer-readable recording medium reflecting one aspect of the present invention is a non-transitory computer-readable recording medium storing a program for a radiography control apparatus that controls a radiographic imager capable of capturing a radiographic image by irradiation with radiation,
the program causing a computer to perform processing comprising:
controlling the radiographic imager in an intermittent imaging mode in which a plurality of times of capturing of a dynamic image by the radiographic imager are allowed during one imaging period from an imaging start to an imaging end, and
determining the imaging end in the one imaging period based on a predetermined condition.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1A is illustrates a radiographic imaging system according to an embodiment of the present invention;

FIG. 1B is illustrates an example of a configuration of a radiation source;

FIG. 2 is a block diagram showing a configuration of a main part of the control system according to the present embodiment;

FIG. 3 is a diagram schematically illustrating pulse irradiation in a normal imaging mod;

FIG. 4 is a diagram schematically showing an example of pulse irradiation in the intermittent imaging mode;

FIG. 5 is illustrates a state transition of the exposure switch in one imaging period;

FIG. 6 is a flowchart illustrating an operation example of the examination processing by the imaging controller;

FIG. 7 is illustrates an example of a display screen of a display section; and

FIG. 8 is illustrates a radiographic imaging system according to a modification example.

### DETAILED DESCRIPTION OF EMBODIMENTS

Hereinafter, one or more embodiments of the present invention will be described with reference to the drawings. However, the scope of the invention is not limited to the disclosed embodiments.

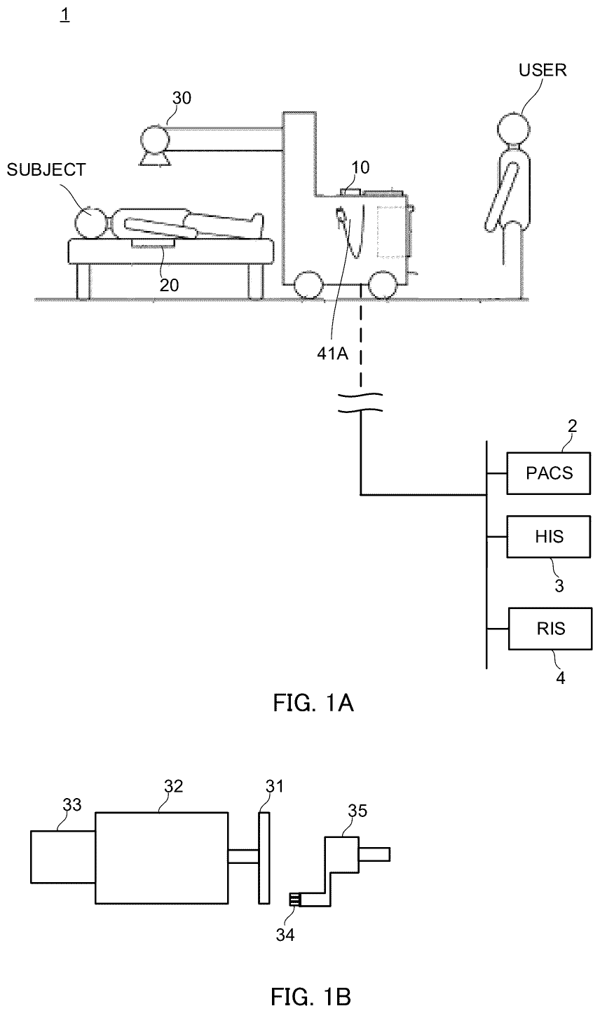

Hereinafter, an embodiment of the present invention will be described in detail with reference to the drawings. FIG. 1A is illustrates a radiographic imaging system according to an embodiment of the present invention.

As illustrated in FIG. 1A, the radiographic imaging system 1 according to the present embodiment is capable of capturing still images and dynamic images and is a visiting system for visiting a subject who has difficulty in moving and capturing radiographic images. Note that the radiographic imaging system 1 is applicable to, for example, a hospital room, an intensive care unit (ICU), and an operating room.

The radiographic imaging system 1 includes a main body 10, one or more flat panel detectors (FPDs) 20, and a radiation emitting apparatus 30.

Furthermore, an external system is connected to the radiographic imaging system 1 via a communication network. The external systems include picture archiving and communication systems (PACS) 2, hospital information systems (HIS) 3, and radiology information systems (RIS) 4, and the like.

In the communication network including the radiographic imaging system 1, PACS2, HIS3, and RIS 4, for example, information is transmitted and received in accordance with a digital image and communications in medicine (DICOM) standard.

The FPD 20 is a portable radiographic detector that is compatible with capturing still images and dynamic images. The FPD 20 includes, for example, radiation detection element two dimensionally arranged on a glass substrate. The radiation detection element is formed by semiconductor image sensors, such as photodiodes. The radiation detection element detects, in accordance with the intensity thereof, radiation that has been emitted from the radiation emitting apparatus 30 (radiation source) and has passed through at least a subject, converts the detected radiation into electrical signals, and accumulates the electrical signals. For example, a switching section such as a thin film transistor (TFT) is connected to each radiation detection element. The switching section controls the accumulation and reading of the electrical signal, and image data is acquired.

Note that FPD 20 may be of an indirect conversion type in which radiation is converted into electrical signals by photoelectric conversion element via a scintillator, or may be of a direct conversion type in which radiation is directly converted into electrical signals.

The FPD 20 is connected to the main body 10 of the radiographic imaging system 1 via a network, and performs wired communication or wireless communication with the main body. To be specific, the FPD 20 receives various control signals from the main body 10 and transmits generated image data to the main body 10 via the communication cable.

Furthermore, the main body 10 is provided with a housing section (not illustrated) capable of housing FPD 20. The main body 10 is conveyed to a hospital room in a state where the FPD 20 is housed in the housing section.

The radiation emitting apparatus 30 includes a synchronization signal output section (not illustrated), a generator (not illustrated), and a radiation source (not illustrated). The radiation emitting apparatus 30 and FPD 20 correspond to the “radiographic imager” according to the present invention.

The synchronization signal output section outputs a pulsed synchronization signal to each of the generator and the FPD 20 in response to operation of an exposure switch 41A, which will be described later. In the imaging of the still image, the synchronization signal is transmitted only once per still image, and in the capturing of the dynamic image, the synchronization signal of the same cycle is repeatedly transmitted a plurality of times.

Each time a synchronization signal is input from the synchronization signal output section, the generator is configured to be able to apply a voltage corresponding to a preset radiation irradiation conditions (tube voltage, tube current, irradiation time, or the like) to the radiation source.

The radiation source (tube) includes a rotary anode, a filament, and the like. As illustrated in the FIG. 1B, the rotating positive electrode is composed of, in addition to the target 31, a rotor for rotating the positive electrode or a positive electrode rotor 32, a positive electrode shaft 33, a bearing (not illustrated) and the like. The anode rotor 32 rotates the target 31 at a high speed by the principle of an induction motor. The filament 34 is provided on a cathode sleeve 35 arranged at a position facing the target 31. When a voltage is applied from the generator, the filament 34 emits an electron beam corresponding to the voltage toward the target 31 of the rotating anode, and the target 31 of the rotating anode generates radiation at a dose corresponding to the intensity of the electron beam.

In addition, the radiation source is rotated by a rotation shaft extending in the horizontal direction, and can be switched to a state in which an irradiation port of radiation is directed in the horizontal direction (a state in which imaging in a standing position is performed) or a state in which the irradiation port is directed in the vertical direction (a state in which imaging in a lying position is performed).

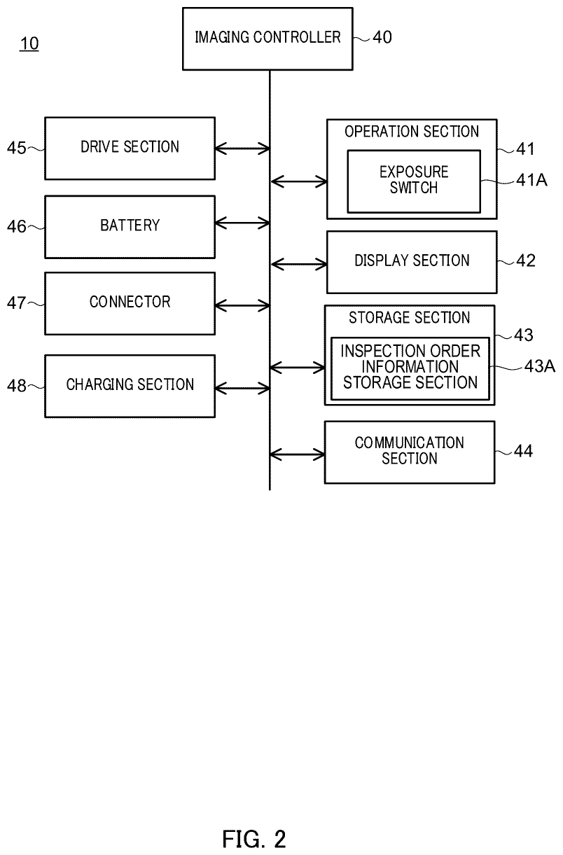

The main body 10 has a function as a console (radiography control apparatus). As shown in FIG. 2, the main body 10 includes an imaging controller 40, an operation section (i.e., operator) 41, a display section (i.e., display) 42, a storage section 43, a communication section 44, a drive section 45, a battery 46, a connector 47, a charging section 48, and the like.

The imaging controller 40 is housed in the main body 10 and includes a central processing unit (CPU), a read only memory (ROM), a random access memory (RAM), and the like. In the imaging controller 40, the CPU reads a program corresponding to the processing details from the ROM and develops it in the RAM. Then, the imaging controller 40 cooperates with the developed program to centrally control the operation of each section.

In addition, the imaging controller 40 performs control such that a radiographic image is captured in an intermittent imaging mode in which capturing of dynamic image or still image by the FPD 20 can be performed a plurality of times during one imaging period from the start of the imaging (herein also simply referred to as “imaging start”) to the end of the imaging (herein also simply referred to as “imaging end”). The control of the intermittent imaging mode by the imaging controller 40 will be described later.

The operation section 41 includes a touch screen or the like in which transparent electrodes are arranged in a lattice shape so as to cover the surface of the display section 42. The touch screen detects a position pressed with a finger, a touch pen, or the like, and inputs the position information as operation information to the imaging controller 40.

The operation section 41 includes an exposure switch 41A for operating the radiation emitting apparatus 30. The exposure switch 41A is a switch for a user to instruct radiation irradiation by the radiation emitting apparatus 30. The display section 42 includes a monitor such as a liquid crystal display (LCD) or a cathode ray tube (CRT).

The display section 42 performs display in accordance with an instruction of a display signal input from the imaging controller 40.

The storage section 43 is composed of a nonvolatile semiconductor memory, a hard disk and the like. The storage section 43 stores various programs executed by the imaging controller 40, parameters necessary for execution of processing by the programs, or data such as processing results.

Furthermore, the storage section 43 includes an inspection order information storage section 43A and the like. The inspection order information acquired from RIS 4 is stored in the inspection order information storage section 43A. Here, the inspection order information includes information on the subject and inspection information. The information on the subject includes the subject ID, name, gender, age, hospital room (ward), and the like of the inspection target. The inspection information includes an inspection ID, an inspection date, and an imaging order for each imaging operation to be performed at the inspection. The imaging order includes an imaging region, an imaging direction, a classification of still image capturing/dynamic image capturing, and the like.

Further, the storage section 43 is provided with a primary storage area (not illustrated) for temporarily storing the radiographic image transferred from the FPD 20. Furthermore, the storage section 43 is provided with an image storage area (not illustrated) for storing the radiographic image transferred from the storage section FPD 20 in association with supplementary information for a certain period of time.

The communication section 44 transmits and receives data to and from the communicator FPD 20 by wired communication or wireless communication. Furthermore, the communication section 44 transmits and receives data to and from an external device, such as the RIS and the PACS, via a network.

The drive section 45 is a circuit that drives a tube of a radiation source of the radiation emitting apparatus. The drive section 45 and the radiation source are connected to each other via a cable.

The battery 46 supplies electric power to each section of the main body 10 and the radiation source. The battery 46 can be charged from the outside via an AC cable.

The connector 47 is provided inside the housing section and is electrically connected to the FPD 20 housed in the housing section.

The charging section 48 charges the FPD 20 connected via the connector 47 with electric power supplied from the battery 46 based on the control by the imaging controller 40.

Next, the control of the imaging mode by the imaging controller 40 will be described.

In the conventional imaging of a dynamic image, during a period from the start of imaging to the end of imaging, pulse irradiation from the radiation source based on the above-described synchronization signal is continuously performed, and a dynamic image composed of a series of a plurality of frames is acquired.

However, in imaging of a radiographic image, a total dose is limited in consideration of an exposure dose to a subject. In particular, in imaging outside the imaging room, the total dose in one imaging is further limited from the viewpoint of risk management. Due to such a limitation, the radiographic imaging system 1 cannot perform pulse irradiation with radiation for a relatively long time. For this reason, it is desirable to perform imaging a plurality of times in a necessary period in one imaging period from the imaging start to the imaging end.

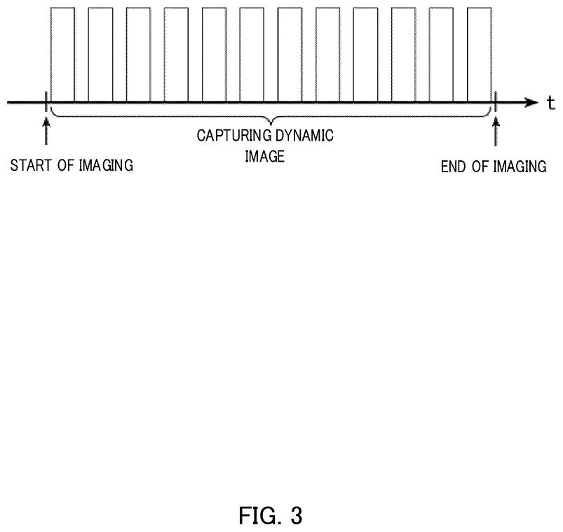

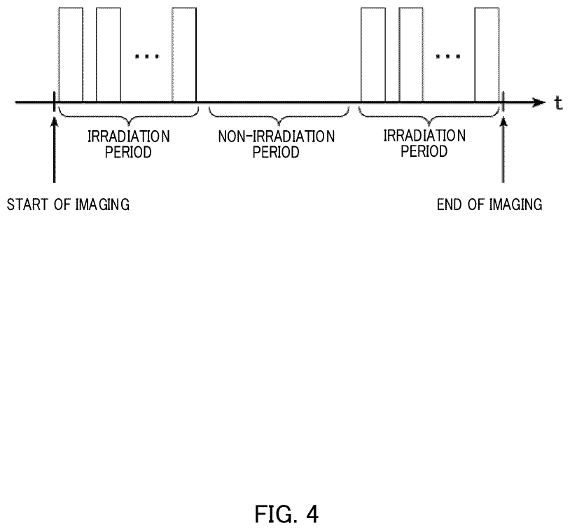

The radiographic imaging system 1 according to the present embodiment has a normal imaging mode and an intermittent imaging mode as imaging modes including a dynamic image. FIG. 3 is a diagram schematically illustrating pulse irradiation in a normal imaging mode. FIG. 4 is a diagram schematically illustrating pulse irradiation in an intermittent imaging mode.

As shown in FIG. 3, the normal imaging mode is an imaging mode for capturing a dynamic image by continuously performing pulse irradiation from the radiation source in one imaging period from the start of imaging to the end of imaging. One imaging period in the normal imaging mode is a period in which continuous pulse irradiation for imaging of a dynamic image continues, and is set based on the total dose in one imaging. In the normal imaging mode, a dynamic image constituted by a series of a plurality of frames corresponding to the entire imaging period set in the normal imaging mode is acquired.

The intermittent imaging mode is an imaging mode in which capturing of dynamic images or still images by a FPD 20 can be performed a plurality of times during one imaging period from the start of the imaging to the end of the imaging. Specifically, the intermittent imaging mode is an imaging mode in which an irradiation period of radiation and a non-irradiation period of radiation are alternately generated so that the irradiation period of radiation occurs at least twice in one imaging period from the start of the imaging to the end of the imaging. Note that the intermittent imaging mode is an imaging mode in which at least two irradiation periods are scheduled or an imaging mode in which at least two irradiation periods can be set. Therefore, for example, in a case where one imaging period ends due to some factor such as the total dose before the second irradiation period starts, the imaging may end in only one irradiation period even in the intermittent imaging mode.

The irradiation period of radiation (herein also referred to as “radiation irradiation period”) is a period for capturing at least one of a dynamic image and a still image. The non-irradiation period of radiation (herein also referred to as “radiation non-irradiation period”) is a period in which the at least one of the dynamic image and the still image is not captured, and is, for example, a period in which the rotary anode is on standby while being rotated.

For example, a period in which continuous pulse irradiation is performed in imaging of a dynamic image corresponds to a radiation irradiation period. A period in which pulse irradiation is not performed in the still image and the dynamic image corresponds to a non-irradiation period of radiation. The period in which the pulse irradiation is not performed does not include the low period within the period in which the continuous pulse irradiation is performed in the capturing of the dynamic image. The low period is a period between two adjacent pulses in a period in which continuous, regular, or periodic pulse irradiation is performed.

One imaging period from the start of the imaging to the end of the imaging in the intermittent imaging mode (hereinafter, referred to as one imaging period) is, for example, a period in which a predetermined subject is in an imageable state in the radiographic imaging system 1. Therefore, in a case where another subject enters a state in which imaging can be performed after imaging of a predetermined subject ends, a period in which the other subject is in the state in which imaging can be performed is not included in one imaging period relating to imaging of the predetermined subject. Furthermore, one imaging period may be a period that is set based on a total dose in at least two or more irradiation periods of radiation, an examination time set for a predetermined subject, or the like. In addition, one imaging period is a period that can be changed in accordance with the non-irradiation period of radiation.

In addition, in a case where the predetermined subject is in an imaging incapable state in the radiographic imaging system 1 during a state in which the predetermined subject is in an imaging capable state, it is assumed that one imaging period relating to the imaging capable state ends. The imaging incapable state refers to a state in which radiographic imaging in the radiation imaging system 1 is ended, a state in which radiographic imaging in the radiation imaging system 1 is stopped, or the like.

FIG. 4 illustrates an example in which two irradiation periods (periods for capturing dynamic image) and one non-irradiation period therebetween occur in one imaging period.

In the normal imaging mode, upon detection of irradiation with radiations after the start of imaging is notified, the FPD 20 starts accumulation and reading of charges corresponding to the radiations. When no radiation is detected for a predetermined time or longer, FPD 20 recognizes the end of imaging and ends the accumulation and reading of charges.

In the intermittent imaging mode, after the imaging start of one imaging period is notified, the FPD 20 starts accumulation and reading of charges corresponding to the radioactive ray when the irradiation of the radioactive ray is detected in accordance with the start of the irradiation period, and ends the accumulation and reading of charges in accordance with the end of the irradiation period. The projector FPD 20 repeats such an operation for each irradiation period. By such an operation, it is possible to easily determine the irradiation period, that is, the break of one intermittent imaging.

In addition, in the intermittent imaging mode, an image confirmation operation of connecting the respective radiographic images acquired in two or more irradiation periods in one imaging period is performed. For example, a summary image, which is a frame in which an imaging condition is described, may be inserted into a connection portion of each radiographic image. In the summary image, for example, information such as an imaging condition and an imaging interruption time of the intermittent imaging in which the frame immediately before the connection portion is imaged may be described. In addition, the number of frames corresponding to a non-irradiation period of radiation may be inserted in a connection portion of each radiographic image. The frame to be inserted may be, for example, a copy of the last frame, an entirely black frame, or a frame of a predetermined pattern.

In addition, the image confirmation operation may be an operation of separately storing a plurality of radiographic images corresponding to a plurality of irradiation periods and confirming each of the plurality of radiographic images as an image of an inspection result. This operation can be applied to a case where, when there is an unnecessary image among a plurality of radiographic images acquired in one imaging period, the image is deleted and the remaining images are managed as inspection images. Note that the images captured in the intermittent imaging mode may all be automatically combined and saved or may be individually saved by presetting or the like. In this case, the image confirmation operation described above is omitted.

The non-irradiation period of radiation includes a standby period and an interruption period. The standby period includes a period in which irradiation with radiation is on standby from the start of imaging in one imaging period until the start of the first irradiation period, which is provided in some cases. In addition, the standby period includes a period in a case where the end of imaging is waited after the end of the last irradiation period in one imaging period. This standby period may or may not be provided in one imaging period.

The interruption period is a non-irradiation period between a predetermined irradiation period and an irradiation period subsequent to the predetermined irradiation period, and is a period in which radiation irradiation is interrupted in one imaging period. For example, in the case of an inspection in which three irradiation periods are scheduled in one imaging period, the non-irradiation period between the first irradiation period and the second irradiation period and the non-irradiation period between the second irradiation period and the third irradiation period correspond to the interruption periods.

Next, detailed control of the intermittent imaging mode will be described.

In the above-described intermittent imaging mode, the irradiation period and the non-irradiation period can be variably controlled based on the operation state of the user exposure switch 41A by the user. That is, in the intermittent imaging mode, each of the irradiation period and the non-irradiation period in one imaging period is freely set by the operation of the user.

In other words, the imaging controller 40 variably controls each of the irradiation period and the non-irradiation period in the intermittent imaging in the intermittent imaging mode according to the operation maintenance state of the radiation emitting apparatus 30 on the exposure switch 41A.

For example, it is assumed that the exposure switch 41A is a switch that can be switched to three states of open state, first stage, and second stage. The open state of the exposure switch 41A is assigned to a state in which the radiation emitting apparatus 30 is stopped. The first stage of the exposure switch 41A is assigned to a state corresponding to a non-irradiation period. The second stage of the exposure switch 41A is assigned to a state corresponding to a radiation irradiation period.

For example, when the user changes the exposure switch 41A from the open state to the first stage or the second stage, the imaging controller 40 controls the radiation emitting apparatus 30 to operation. When the exposure switch 41A that has been open is switched to the first stage or the second stage by the user, one imaging period starts imaging.

In a case in which the exposure switch 41A is switched from the open state to the first stage, the radiation emitting apparatus 30 waits for the irradiation without performing the irradiation after completing the irradiation preparation. That is, the imaging controller 40 performs control such that the radiation non-irradiation period starts after the start of imaging in one imaging period.

Here, when the exposure switch 41A is maintained at the first stage, the imaging controller 40 performs control so as to maintain the non-irradiation period. That is, as long as the exposure switch 41A is in the first stage, the non-irradiation period continues.

When the exposure switch 41A is switched from the first stage to the second stage, the radiation emitting apparatus 30 starts irradiation. That is, the imaging controller 40 performs control to end the non-irradiation period of radiation and enter the irradiation period of radiation.

In addition, when the exposure switch 41A is switched from the open state to the second stage, the radiation emitting apparatus 30 starts irradiation with radiation after completing irradiation preparation. That is, the imaging controller 40 performs control such that the radiation irradiation period starts after the start of imaging in one imaging period.

Here, when the type of the captured image is a dynamic image and the exposure switch 41A is maintained at the second stage, the imaging controller 40 performs control so as to maintain the irradiation period of radiation. That is, as long as the exposure switch 41A is in the second stage, the radiation irradiation period continues, and the imaging of the dynamic image continues.

Next, when the exposure switch 41A is switched from the second stage to the first stage, the radiation emitting apparatus 30 ends the irradiation and waits for the irradiation. That is, the imaging controller 40 performs control to end the radiation irradiation period and enter the radiation non-irradiation period.

In addition, when the type of the captured image is a still image, the radiation emitting apparatus 30 emits radiation necessary for capturing the still image and then waits for the emission of radiation. That is, the imaging controller 40 performs control to end the radiation irradiation period and enter the radiation non-irradiation period. In other words, in a case of capturing a still image, the imaging controller 40 ends the capturing of the still image based on the irradiation time of radiation regardless of the operation of the exposure switch 41A.

In this case, the exposure switch 41A is in the second stage, but the exposure switch 41A may be automatically switched to the first stage, or control may be performed to prompt the user to switch the exposure switch 41A. The control for prompting the user may be, for example, control for displaying character information for prompting the user to set the exposure switch 41A to the first stage on the display section 42 or control for outputting audio information for prompting the user to set the exposure switch 41A to the first stage.

In this way, in the intermittent imaging mode, the exposure switch 41A is switched between the first and second stages, so that irradiation periods and non-irradiation periods occur alternately. Then, each of the irradiation period and the non-irradiation period is variably controlled based on an operation state of the exposure switch 41A.

Therefore, the non-irradiation period can be easily adjusted in order to adjust the imaging timing (start timing of the irradiation period) of the radiographic image to the movement of the subject, and the irradiation period can also be easily adjusted in order to sufficiently obtain the movement of the subject as a dynamic image in the imaging of the dynamic image. As a result, it is possible to improve the degree of freedom of imaging compared to a configuration in which the non-irradiation period and the irradiation period are fixed.

Furthermore, in a case of capturing a dynamic image, the imaging controller 40 may determine the end of the dynamic image based on the number of frames of the dynamic image. In this case, the exposure switch 41A is in the second stage, but the exposure switch 41A may be automatically switched to the first stage, or control may be performed to prompt the user to switch the exposure switch 41A. The control for prompting the user is the same as the above-described control performed when the still image ends.

In addition, the number of frames of the dynamic image, which is a criterion for determining the end of the dynamic image, can be appropriately set based on the total dose in all imaging in one imaging period and the minimum required dose in other radiographic images in one imaging period.

Although the irradiation period can be variably controlled, when the number of frames of one dynamic image is too large, the total dose in all imaging operations in the one imaging period is increased, which may affect imaging of other radiographic images.

Therefore, by limiting the number of frames of a single dynamic image, it is possible to reliably capture a radiographic image scheduled within one imaging period.

There is a case, for example, where a situation in which a subject is caused to move an examination target site in all directions is captured as a dynamic image. This situation is, for example, a situation in which the subject is asked to move his/her wrist in a specified direction and then move it in a different direction, which is repeated. In this case, when the entire movement is imaged in one irradiation period, it takes time and effort to divide the radiographic image later. Since the movement in one direction is completed in about 5 seconds, the maximum number of frames of one irradiation period (for example, a maximum of 75 frames (a maximum of 5 seconds)) in 15 fps) is set in advance, and the irradiation period can be forcibly divided in imaging. As a result, it is possible to save time and effort to divide the radiographic image later.

Furthermore, in the radiation irradiation period, the imaging controller 40 may distinguish between dynamic image and still image, for example, based on the order of imaging in the intermittent imaging mode in an inspection order or the like.

For example, in the inspection order, it is assumed that the number of times of imaging in one imaging period is three, the type of the first captured image is a still image, and the type of the second and third captured images is a dynamic image.

In this case, a radiographic image when the exposure switch 41A is first switched to the second stage is a still image. Then, the radiographic image when the exposure switch 41A is set to the second stage for the second and third times is a dynamic image.

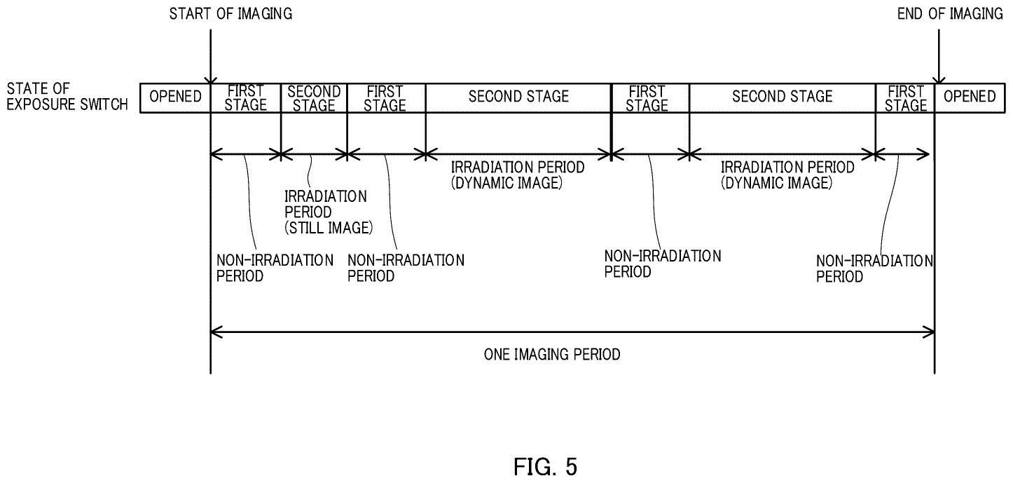

FIG. 5 shows an example of the state transition of the exposure switch 41A according to the inspection order. In FIG. 5, the state of the exposure switch 41A transitions to the open state, the first stage, the second stage, the first stage, the second stage, the first stage, the second stage, the first stage, and the open state by the user's operation.

According to the inspection order described above, the irradiation period when the exposure switch 41A is switched to the second stage for the first time is a period corresponding to the capturing of a still image. The radiation irradiation period when the exposure switch 41A is switched to the second stage for the second and third times is a period corresponding to the capturing of a dynamic image.

In addition, when the radiation irradiation period starts, the imaging controller 40 may identify the dynamic image and the still image based on, for example, the setting of the operation section 41.

For example, before switching to the irradiation period by the exposure switch 41A, the user sets the type of captured image to dynamic image or still image via the operation section 41. Based on this setting, the imaging controller 40 identifies the dynamic image and the still image.

In this case, the radiographic image becomes a dynamic image when the type of the captured image is set to the dynamic image, and the radiographic image becomes a still image when the type of the captured image is set to the still image.

Furthermore, when the operation section 41 includes a plurality of types of exposure switches, such as a hand switch and a foot switch, the still image and the dynamic image may be allocated to the different types of exposure switches.

Furthermore, in order that the user can recognize that one of the dynamic image and the still image is being captured, the imaging controller 40 may change the transmission state of each of the types of imaging (capturing of the dynamic image and capturing of the still image) during the irradiation period. For example, when the type of imaging is conveyed by the audio output section, the sound outputted (pitch, sound pattern, etc) may be different between the capturing of a dynamic image and the capturing of a still image. In addition, in a case where the type of imaging is transmitted by a visual transmission function such as a lamp, a visual state (a color, a light emission pattern, an apparent shape, or the like) of the visual transmission function may be different between the imaging of the dynamic image and the imaging of the still image. Furthermore, in still image capturing, in a case where the exposure switch 41A is set to the second stage for a certain period from a specific timing (such as the start of irradiation or the completion of irradiation) related to still image capturing, a warning sound may be generated by the sound output section. In this case, the display section 42 may display a warning message. Further, in the imaging of the dynamic image in which the number of frames is limited, even in a case where the exposure switch 41A is set to the second stage for a certain period from a specific timing related to the imaging of the dynamic image (the start of irradiation of the last frame, the completion of irradiation, or the like), the warning sound may be generated by the sound output section. In this case, the display section 42 may display a warning message.

As described above, the type of the radiographic image can be easily distinguished by a simple operation.

In addition, the imaging controller 40 determines the end of the intermittent imaging (irradiation period) of the radiographic image by switching the exposure switch 41A from the second stage to the first stage as described above, and determines the imaging end of one imaging period based on an operation different from the end. In other words, the imaging controller 40 determines the end of intermittent imaging in the intermittent imaging mode separately from the determination of the end of imaging in one imaging period.

The end of imaging in one imaging period may be the switching of the exposure switch 41A from the first stage or the second stage to the open state (see FIG. 5), or may be the elapse of the time set in one imaging period.

For example, when necessary imaging is completed in one imaging period, the user switches the exposure switch 41A to the open state. In this case, the imaging controller 40 determines the end of imaging in the one imaging period.

Furthermore, assume that since necessary imaging has been completed in one imaging period, the user has set the exposure switch 41A to the first stage and left it in the non-irradiation period. In this case, the imaging controller 40 determines the end of imaging in one imaging period when the time set in the one imaging period has elapsed. In other words, the imaging controller 40 determines the end of imaging in one imaging period in accordance with the elapse of time during the non-irradiation period of radiation next to the irradiation period of radiation in the intermittent imaging mode.

For example, during one imaging period, a situation in which the imaging of the radiographic image cannot be continued may occur, such as a situation in which it is necessary to change the setting of the imaging of the radiographic image, a situation in which the remaining amount of the battery 46 is low, or a situation in which the subject cannot continue the imaging. In this case, since it is necessary to stop imaging in the intermittent imaging mode, the user switches the exposure switch 41A to the open state.

Accordingly, the imaging controller 40 determines the end of imaging in one imaging period. Specifically, when the imaging controller 40 determines the end of imaging in one imaging period before ending the intermittent imaging in the intermittent imaging mode, the imaging controller 40 applies the determination of the end of imaging in one imaging period and ends the irradiation (imaging) by the radiation emitting apparatus 30. In a case where the imaging controller 40 determines the end of imaging in one imaging period before determining the end of intermittent imaging in the intermittent imaging mode, the imaging controller 40 ends irradiation by the radiation emitting apparatus 30 without determining the end of intermittent imaging.

With such a configuration, since the determination of the end of the intermittent imaging is omitted by the determination of the end of the imaging in one imaging period, it is possible to suppress the imaging controller 40 from performing the determination process twice.

In addition, the user may erroneously switch the exposure switch 41A to the open state. In this case, when it is determined that the imaging of one imaging period is completed, the imaging which is not completed cannot be performed. Therefore, the imaging controller 40 may cancel the determination of the end of imaging when an operation of switching the exposure switch 41A to the first stage or the second stage is performed within a predetermined time after the determination of the end of imaging during one imaging period is performed. In other words, the imaging controller 40 may continue the non-irradiation period of radiation in the intermittent imaging mode without determining the end of imaging when a predetermined operation is performed after the imaging controller 40 acquires a command to end imaging in one imaging period.

In this manner, one imaging period continues, and the state of the radiation emitting apparatus 30 transitions during the irradiation period or the non-irradiation period of radiation, thereby allowing to perform imaging that is not completed.

The imaging controller 40 may control the display mode of the display section 42 so that the user can distinguish between the radiation irradiation period and the radiation non-irradiation period. For example, the imaging controller 40 performs control to display, on the display section 42, a notification such as an image or an icon capable of identifying a radiation irradiation period and a radiation non-irradiation period.

Note that the display mode of the radiation irradiation period may be the same or different between the intermittent imaging mode and the normal imaging mode.

In addition, for example, a period during the irradiation preparation in one imaging period or a period other than one imaging period is a period in which radiation is not emitted as in the radiation non-irradiation period, but is different from the radiation non-irradiation period. Therefore, the imaging controller 40 may change the display form of the display section 42 or the state of a state indicator (not illustrated) or the like between the period during the irradiation preparation and the period other than the one imaging period and the non-irradiation period of radiation.

Furthermore, the imaging controller 40 may perform control in such a manner as to display, on the display section 42 or the like, a message indicating that the time set in one imaging period will be reached. For example, the imaging controller 40 may display, on the display section 42 or the like, the number of seconds required to reach the time. Further, the imaging controller 40 may change the display color or pattern of the state indicator or the like according to the number of seconds until the time is reached.

Furthermore, the imaging controller 40 may perform control so as to display, on the display section 42, a tube monitor, or the like, guide information such as an operation guide for the operation section 41, that is, a method for transitioning to a non-irradiation period of radiation, a method for continuing a non-irradiation period of radiation, or the like. In addition, the imaging controller 40 may control the display section 42 or the like to display guide information indicating the end of imaging in one imaging period in accordance with the above configuration. The imaging controller 40 may display the guide information differently between the intermittent imaging mode and the normal imaging mode. In the normal imaging mode, the guide information may not be displayed.

Further, the imaging controller 40 may perform control so as to notify the user of information about the delay time at the time of transition from the radiation non-irradiation period to the radiation irradiation period.

The control of notifying the user may be, for example, control of displaying the count display of the delay time, the hourglass display of the delay time, the bar display of the delay time, or the like on the display section 42 so as to be visually recognized. In addition, the control of notifying the user may be control of outputting sound when the non-irradiation period is switched to the irradiation period. The control for notifying the user may be display control on a display section (LED or the like) provided in the exposure switch 41A or the like. The notification of the information on the delay time may be a notification of the delay time itself. In addition, the notification of the information regarding the delay time may be performed only when the delay time is longer than a normal delay time in consideration of convenience in use. In this case, the notification of the information on the delay time may be notification of information on a change in the delay time or notification of information on the magnitude level (for example, divided into three stages) of the delay time. In addition, the notification of the information regarding the delay time may be notification of information indicating whether or not the delay time exceeds a predetermined threshold value. In this case, the notification may be performed only when the delay time exceeds a threshold value. Furthermore, since the degree of demand for a delay in the timing of restarting irradiation varies depending on the imaging order, the threshold value may be automatically settable according to the imaging order.

Since one imaging period is longer in the intermittent imaging mode than in the normal imaging mode, control for coping with the longer imaging period (e.g., stop or re-rotation control of the rotor) is performed, and thus the above-described delay time might not be constant. In the intermittent imaging mode, since interruption and resumption of irradiation are repeated for medical purposes, when the irradiation resumption timing is delayed, there is a possibility that a subject in a desired state cannot be imaged. Therefore, performing control to notify the user of the delay time in advance can make it easier for the user to take measures such as restarting irradiation early in anticipation of the delay time.

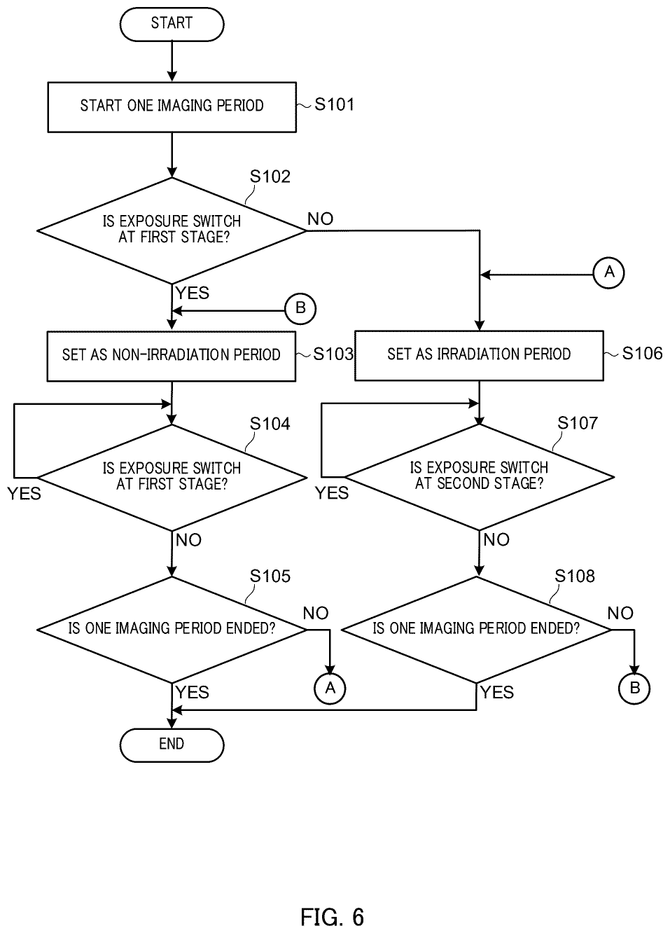

Next, a flow of processing performed by the imaging controller 40 will be described. FIG. 6 is a flowchart showing an operation example of the examination processing by the imaging controller 40. The present control is started when the input imaging condition is based on the intermittent imaging mode.

As shown in FIG. 6, the imaging controller 40 determines the start of imaging in one imaging period based on the operation of the exposure switch 41A and the imaging ready state of the radiographic imaging system 1 (step S101). In detail, when the exposure switch 41A is pressed to at least the first stage (or may be pressed to the second stage), the imaging controller 40 starts preparing for imaging and instructs an apparatus that needs to prepare for imaging, such as the radiation emitting apparatus 30 or the FPD 20, to start preparing for imaging. Upon receiving the instruction, these apparatuses prepare for imaging and notify the imaging controller 40 that the preparation is completed. For example, the radiation emitting apparatus 30 performs control to set the heating state of the filament and the rotation state of the tube rotor to a state in which imaging can be performed. Upon receiving the imaging preparation completion notification from the apparatus that requires imaging preparation, the imaging controller 40 determines to start imaging. Next, the imaging controller 40 determines whether or not the exposure switch 41A is in the first stage (step S102).

As a result of the determination, when the exposure switch 41A is in the first stage (step S102, YES), the imaging controller 40 controls the radiation emitting apparatus 30 to be in the non-irradiation period (step S103).

After step S103, the imaging controller 40 determines whether the exposure switch 41A remains at the first stage (step S104). As a result of the determination, when the exposure switch 41A remains at the first stage (YES in step S104), the processing in step S104 is repeated.

On the other hand, when the exposure switch 41A is not at the first stage (NO in step S104), the imaging controller 40 determines whether one imaging period satisfies the imaging end condition (step S105). When it is determined that the one imaging period does not satisfy the imaging end condition (NO in step S105), the exposure switch 41A is switched to the second stage, and the process advances to step S106.

On the other hand, when the one imaging period satisfies the imaging end condition (step S105, YES), the present control is ended. Note that when the one imaging period satisfies the imaging end condition while the processing in step S104 is being repeated, the present control may be ended.

Returning to the determination in step S102, when the exposure switch 41A is not in the first stage (step S102, NO), the imaging controller 40 controls the radiation emitting apparatus 30 to be in the irradiation period (step S106).

After step S106, the imaging controller 40 determines whether the exposure switch 41A remains at the second stage (step S107). As a result of the determination, when the exposure switch 41A remains at the second stage (YES in step S107), the process in step S107 is repeated.

On the other hand, when the exposure switch 41A is not in the second stage (NO in step S107), the imaging controller 40 determines whether one imaging period satisfies the imaging end condition (step S108). When it is determined that the one imaging period does not satisfy the imaging end condition (NO in step S108), the exposure switch 41A is switched to the first stage, and the process advances to step S103.

On the other hand, when the one imaging period satisfies the imaging end condition (step S108, YES), the present control is ended. Note that when the one imaging period satisfies the imaging end condition while the processing in step S107 is being repeated, the present control may be ended.

According to the present embodiment configured as described above, since the radiation emitting apparatus 30 is controlled in the intermittent imaging mode, a period necessary for observation can be set as the irradiation period, and the other periods can be set as the non-irradiation period.

Thus, a radiographic image can be formed in a necessary period, and the subject is not irradiated with radiation in other periods, so that an increase in the exposure dose of the subject can be suppressed in the intermittent imaging mode. In addition, since it is also possible to suppress the temperature rise of the tube and the load per unit time on the tube and the generator, it is possible to relax restrictions on one imaging operation (for example, the maximum time of one imaging operation, the maximum number of irradiation pulses of one imaging operation, and the like) due to the temperature rise and the load, compared to the normal imaging mode. That is, it is possible to acquire a radiographic image of a necessary period by an easy-to-use operation while minimizing restrictions on imaging due to the apparatus and suppressing an increase in the exposure dose of the subject.

Furthermore, separately from the determination of the end of intermittent imaging in one imaging period, the end of intermittent imaging in the intermittent imaging mode is determined. That is, the end of imaging in one imaging period is distinguished from the end of intermittent imaging in the intermittent imaging mode. Therefore, for example, the non-irradiation period may be set after the end of the intermittent imaging, or the imaging of one imaging period may be ended after the end of the intermittent imaging. Therefore, the degree of freedom after the end of the intermittent imaging can be improved.

In addition, since each of the non-irradiation period and the irradiation period of the radiation is variably controlled according to the operation maintenance state of the exposure switch 41A, it is possible to set all necessary periods as the irradiation period and to continue the non-irradiation period until the necessary period is reached. As a result, it is possible to acquire a radiographic image of a necessary period by an easy-to-use operation while suppressing an increase in the exposure dose of the subject.

In the above embodiment, the end of imaging in one imaging period is determined based on the operation (input information) of the operation section 41 (exposure switch 41A), but the present invention is not limited thereto. For example, the imaging controller 40 may determine the end of imaging in one imaging period based on information on imaging performed within the one imaging period.

The information on imaging performed within one imaging period may be, for example, the number of captured radiographic images, the maximum number of frames based on the frame rate or the dose (kV, mAs, or the like) per frame, the total dose, the total time of intermittent imaging, or the elapsed time of one imaging. The total time of intermittent imaging may be the cumulative elapsed time of all the executed irradiation periods. The elapsed time of a single instance of imaging may be the elapsed time from the start of imaging in one imaging period, in other words, the cumulative elapsed time of all the irradiation periods and non-irradiation periods that have been implemented. Further, the information of imaging performed within one imaging period may be a combination of two or more of these.

For example, when a total dose by imaging within one imaging period becomes relatively large, an exposure dose to a subject increases, and therefore, it is necessary to impose a limitation on the total dose. Therefore, when the number of captured images or the total dose reaches a predetermined threshold value, the imaging controller 40 may determine the end of one imaging period.

In this way, since the end of imaging in one imaging period is determined when imaging performed in one imaging period reaches a limit or the like, it is possible to prevent intermittent imaging from being performed more than the limit.

Furthermore, the imaging controller 40 may determine the end of one imaging period based on both input information to the operation section and information on imaging performed in the one imaging period.

For example, assume that a first threshold value and a second threshold value larger than the first threshold value are set for the number of captured radiographic images (information about imaging performed in one imaging period). In a case in which the number of captured radiographic images is equal to or greater than the first threshold value and less than the second threshold value, the imaging controller 40 causes the display section 42 or the like to display a warning that the number of captured radiographic images is approaching the upper limit value, and then determines the end of one imaging period based on input information to the operation section (opening of the exposure switch 41A). In a case in which the number of captured radiographic images is equal to or greater than the second threshold value, the imaging controller 40 determines the end of one imaging period even when the exposure switch 41A is not opened.

In the above-described embodiment, the end of imaging in one imaging period is determined based on the operation of the exposure switch 41A. That is, the end of imaging in one imaging period is determined by the operation of opening the exposure switch 41A, but the present invention is not limited thereto. For example, the end of imaging may be determined based on the operation of an operation section other than the exposure switch 41A.

For example, the imaging controller 40 may determine the end of imaging in one imaging period based on the operation state of an operation button displayed on the display section 42 capable of displaying a radiographic image being captured in the intermittent imaging mode.

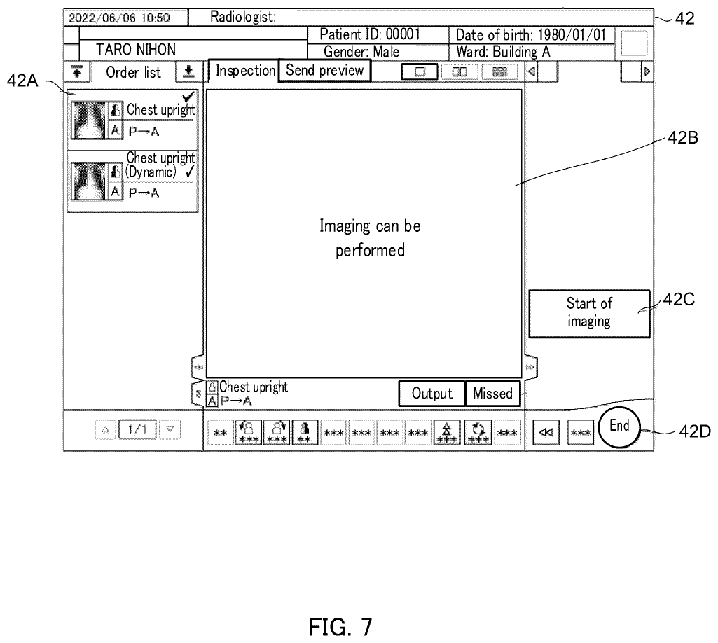

For example, FIG. 7 illustrates an example of a display screen of the display section 42. The display section 42 is provided with an imaging order list 42A, an image display field 42B, an imaging start button 42C, an inspection end button 42D, and the like.

The imaging order list 42A is a list of imaging orders included in the information on the inspection order of the selected inspection. The imaging order includes an imaging region, an imaging direction, a classification of still image/dynamic image, and the like.

The image display field 42B is a field for displaying a captured image. In the image display field 42B, information indicating a state of the system such as “imaging can be performed” is displayed before imaging.

The imaging start button 42C is, for example, a button for giving an instruction to start imaging, such as an intermittent imaging mode. That is, the imaging start button 42C is a button for giving an instruction to start imaging in one imaging period.

The inspection end button 42D is a button for giving an instruction to end the inspection. That is, the inspection end button 42D is a button for instructing the end of imaging in one imaging period.

First, the user selects an imaging order from the imaging order list 42A on the display section 42 by operating the operation section 41, and performs imaging preparation such as positioning. In the main body 10, when an imaging order in the intermittent imaging mode is selected by an operation of the operation section, the imaging controller 40 causes the display section 42 to display text information such as “imaging ready” in conjunction with the operation, and activates an imaging start button 42C.

Then, when the user presses the imaging start button 42C by the operation of the operation section 41, the operation preparation of each device such as the radiation emitting apparatus 30 and FPD 20 is performed. The start of the preparation for the operation of each apparatus may be performed not based on the pressing of the operation start button 42C but based on a timing at which the imaging order of the intermittent imaging mode is selected (the same timing as the above-described timing or a timing after a lapse of a predetermined time from the above-described timing). After each device is prepared for operation, this is the start of imaging in one imaging period. In conjunction with this operation, the display of the imaging start button 42C on the display section 42 is switched to a light display, and the imaging start button 42C cannot be operated.

In response to the operation of the exposure switch 41A, the character information “imaging in progress” and the character information “imaging interrupted” may be displayed on the display section 42 during imaging and when imaging is interrupted. That is, the imaging controller 40 may provide notification of information indicating that imaging is in progress or interrupted, based on the user's operation of the operation section 41. The display of these pieces of text information may be switched in conjunction with switching between the radiation irradiation period and the radiation non-irradiation period.

Next, when the inspection is completed, the user presses an inspection end button 42D on the display screen of the display section 42 by operating the operation section 41. Accordingly, the imaging controller 40 determines the end of imaging in one imaging period.

Thus, it is possible to make it easier to distinguish between determination of the start and end of imaging in one imaging period based on the operation buttons on the display section 42 and determination of the start and end of intermittent imaging based on the exposure switch 41A.

Furthermore, it may be possible to perform an operation or the like on the imaging order list 42A during one imaging period. For example, in order to enable switching of the display on the display section 42 to a captured image obtained by intermittent imaging, an operation for the imaging order list 42A may be performed during one imaging period.

Also, the end of imaging in one imaging period may be after an image confirmation operation in the intermittent imaging mode. That is, after the end of the intermittent imaging in the intermittent imaging mode, the imaging controller 40 may determine the end of imaging in one imaging period after acquiring a command to confirm an image captured by the radiographic imaging system 1, during a period from the start of imaging in one imaging period to the end of the intermittent imaging.

The image confirmation operation may be, for example, an operation such as pressing a button indicating image confirmation displayed on the display section 42 or the like.

Furthermore, although the first stage of the embodiment exposure switch 41A is allocated to the non-irradiation period and the second stage of the exposure switch 41A is allocated to the irradiation period in the embodiment described above, the present invention is not limited thereto. For example, the opening of the exposure switch 41A may be assigned to the non-irradiation period of radiation. That is, the imaging controller 40 may determine the end of intermittent imaging in the intermittent imaging mode and the end of imaging in one imaging period based on the same operation (the operation of opening the exposure switch 41A).

To be specific, after the irradiation period, when the exposure switch 41A is opened, the non-irradiation period starts. When the user operates the exposure switch 41A to change to the second stage by the time the non-irradiation period continues for a predetermined time (e.g., 60 seconds), the imaging controller 40 determines that the non-irradiation period ends. Note that the measurement of the predetermined time may be performed by monitoring a measuring instrument (not illustrated) such as a timer.

Some types of the exposure switch 41A cannot maintain a state in which first and second stages are pressed by the user unless the user continues the state. Therefore, when the first stage and the second stage of the exposure switch 41A are set to the non-irradiation period and the irradiation period, one hand of the user is occupied, and other tasks cannot be performed.

In contrast, in this mode, once the radiation irradiation period has started, the radiation non-irradiation period subsequently starts when the exposure switch 41A is opened, and thus the user can release the exposure switch 41A.

Therefore, during the non-irradiation period of radiation, the user can perform other tasks during the predetermined time. The other tasks may be any task as long as the task is related to capturing of a radiographic image, such as acceptance or rejection of imaging, a change in positioning, or preparation of a contrast agent.

In this embodiment, the start of imaging in one imaging period may be, for example, when the first stage of the exposure switch 41A is pressed. In this case, the radiation emitting apparatus 30 may stand by for the irradiation after the irradiation preparation is performed, and when the second stage of the exposure switch 41A is pressed, the radiation emitting apparatus 30 may start the irradiation.

The imaging controller 40 may determine the end of imaging in one imaging period when a non-irradiation period of radiation continues for a predetermined time in intermittent imaging in the intermittent imaging mode.

Thus, since the exposure switch 41A is kept open for a relatively long time, the imaging controller 40 automatically determines the end of imaging in one imaging period, user convenience can be improved.

The imaging controller 40 may extend the predetermined time and continue the non-irradiation period of radiation based on the specific operation. The specific operation may be setting the exposure switch 41A to the first stage or an operation on the user interface of the radiographic imaging system 1 (for example, pressing of an imaging continuation button).

Thus, in a case where it takes time for the user to perform other tasks and the predetermined time has elapsed, it is possible to prevent the end of imaging.

Furthermore, in this embodiment, after the radiation irradiation period comes once, the opening of the exposure switch 41A is allocated to the radiation non-irradiation period, but it is not limited thereto. For example, in addition to the opening of the exposure switch 41A, the first stage of the exposure switch 41A may be assigned to the non-irradiation period.

According to this, by setting the non-irradiation period to the first stage of the exposure switch 41A, for example, it is possible to prevent the determination of the end of imaging in one imaging period when the non-irradiation period continues for a predetermined time.

Furthermore, although one type of exposure switch is provided in the above embodiment, the present invention is not limited thereto, and a plurality of types of exposure switches (operation section) may be provided.

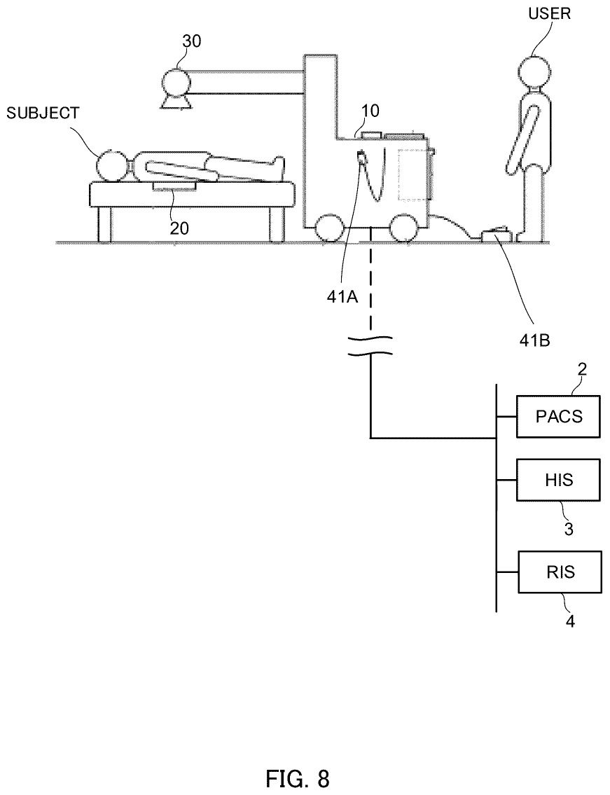

For example, in the configuration shown in FIG. 8, a first exposure switch 41A and a second exposure switch 41B are provided. The first exposure switch 41A is the same as the embodiment exposure switch 41A of the above embodiment.

The second exposure switch 41B is a foot switch that can be operated by a user's foot.

In this form, for example, the operation of the second exposure switch 41B may be an operation indicating one imaging period. That is, by operating the second exposure switch 41B, imaging of one imaging period is started, and by canceling the operation of the second exposure switch 41B, imaging of one imaging period is ended. In other words, while one of the two types of operation sections is operated, the imaging controller 40 performs control such that one imaging period continues and a radiation non-irradiation period is set. Then, the imaging controller 40 performs control such that a period during which one of the two types of operation sections is operated is a radiation irradiation period.

In this way, since the non-irradiation period can be set only by the operation of the second exposure switch 41B, the user can release the first exposure switch 41A in the non-irradiation period. As a result, the above-described other tasks can be performed during the non-irradiation period of radiation.

Further, in this embodiment, the operation of the second exposure switch 41B is the operation indicating one imaging period, and the operation of the first exposure switch 41A is the operation relating to the irradiation period. For example, the operation of the first exposure switch 41A may be an operation indicating one imaging period, and the operation of the second exposure switch 41B may be an operation relating to the irradiation period.

Further, in this form, it is possible for a plurality of users to operate each of the exposure switches 41A and 41B. In the radiographic imaging system 1, a user provides an instruction to move the subject during the radiation non-irradiation period and observes the movement of the subject during the radiation irradiation period to determine the timing of switching from the radiation irradiation period to the radiation non-irradiation period.

Since the instruction of the movement to the subject and the observation of the movement of the subject can be performed by, for example, a user such as a doctor other than the photographer such as a radiology technician, it can be assumed that the inspection is performed by a plurality of users (the instructor, the observer, and the photographer). Therefore, a system that can be efficiently operated by a plurality of users is desired.

The role assignment at the start and end of each image sensing operation among all image sensing operations in one imaging period varies depending on the purpose of image sensing. All imaging is imaging corresponding to all irradiation periods in one imaging period. The individual imaging is imaging corresponding to each irradiation period within one imaging period.

For example, in one example, role sharing is conceivable in which a doctor performs the operation of starting and ending each imaging and a radiologist performs the operation of starting and ending all imaging.

The purpose of imaging in this role sharing may be, for example, to quickly and strictly adjust the start and end of individual imaging. For example, a joint operation of the subject accompanied by tremor, a functional operation of the subject with weakened muscle strength, or the like may not enable the subject to start and end a desired operation at intended timing. In this case, it is difficult to synchronize the operation of the subject with the timings of the start and end of imaging. Therefore, in such a case, a user (doctor) who instructs the subject to perform a motion and observes the motion of the subject performs operation to start and end individual imaging. It is preferable that the doctor operates, for example, an exposure switch corresponding to a foot switch so that his/her hand can be used.

In addition, as another example, role sharing in which a radiologist performs an operation of starting individual imaging and a doctor performs an operation of ending individual imaging is considered.

The imaging purpose in this role sharing may be, for example, to reliably image switching of the movement of the subject from a not-moving state to a moving start state. In such imaging, the possibility of failure in imaging may be reduced by starting the imaging at a timing with a relatively generous margin of error, rather than timing each session to coincide with the start of the subject's movements. On the other hand, since it may be difficult to confirm the end of the movement of the subject unless the subject is observed in the vicinity of the subject, it may be more appropriate for the observer to determine the end. In a case where a doctor (observer) performs the start and the end of the individual imaging, a work burden on the doctor increases, and therefore, the doctor may perform only the operation of ending the individual imaging.

In addition, both the doctor and the radiological technician may perform the operation of ending the individual imaging.

There is a case where the end of each imaging cannot be determined only by the movement of the subject. For example, individual imaging may end due to an abnormal related to the arrangement of the apparatus during imaging. Furthermore, in a case where it is confirmed that there is a deficiency in the imaging condition during imaging, individual imaging may be completed due to an abnormal that can be determined from the radiographic image displayed on the display section 42 during imaging. A radiologist located in the vicinity of the display section of the radiographic imaging system 1 or in charge of setting of the imaging condition often notices such abnormal. Therefore, it is preferable that the radiologist can also end the imaging after each imaging. In this case, the end timing of each imaging is the earlier one of the end instructions from the doctor and the radiologist.

In order to perform such operation of each of the exposure switches 41A and 41B by the plurality of users, the role of each of the exposure switches 41A and 41B can be set, for example, as the following (A) to (G).
(A) All imaging operations and individual imaging operations in one imaging period are performed with the second exposure switch 41B (foot switch), and the first exposure switch 41A (hand switch) is disabled.
(B) The start and end of all imaging operations are performed by the first exposure switch 41A, and the start and end of each imaging operation are performed by the second exposure switch 41B. Thus, for example, a doctor can freely move in both the irradiation period and the non-irradiation period of radiation. Furthermore, a radiologist can be responsible for the entire imaging operation (including, for example, setting and preparation of irradiation conditions), and a doctor can be responsible for imaging timing related to the principle.
(C) In (B) described above, for example, the instruction may be performed with the second exposure switch 41B kept pressed with a foot in an individual imaging period. That is, since the exposure is performed in the period in which both the first exposure switch 41A and the second exposure switch 41B are operated, the security is improved. In addition, since the doctor can freely move during the non-irradiation period of radiation, workability is also improved.
(D) In the above (B), the instruction may be performed in a state where the second exposure switch 41B is kept pressed by the foot during the non-irradiation period of the radiation. Since the doctor only gives an instruction to interrupt exposure (end of individual imaging), the psychological burden of the doctor on the duty of exposure is reduced.
(E) The operation of starting and ending all imaging and the operation of starting and ending individual imaging are performed with the first exposure switch 41A, and the operation of ending individual imaging is also performed with the second exposure switch 41B. The operation of the first exposure switch 41A or the second exposure switch 41B, whichever is operated at an earlier timing, is applied to the end of individual imaging.
(F) In addition to the above (E), an operation to end all imaging operations may also be performed by the second exposure switch 41B. Since a doctor knows more about switching of a series of manipulations than a radiologist, (F) is suitable for a configuration in which all imaging is completed by switching of a series of manipulations.
(G) The operation of starting and ending all imaging and the operation of starting individual imaging are performed by the first exposure switch 41A, and the operation of ending individual imaging is performed by the second exposure switch 41B.

In the above-described embodiment, the imaging condition is not changed during one imaging period, but the present invention is not limited thereto. For example, the imaging controller 40 may change the imaging condition in the middle of one imaging period (during a non-irradiation period of radiation or the like).

In this case, the imaging controller 40 may change the imaging condition related to the limitation of the radiographic image of the entire one imaging period according to the change content of the imaging condition. Specifically, the imaging controller 40 may change at least one of the total number of radiographic images that can be captured and the total imaging time during one imaging period, according to the changes.

For example, the imaging controller 40 may change the imaging condition so that the total number of images is 300 when the frame rate is 15 fps, and the total number of images is 240 when the frame rate is 6 fps. Furthermore, in this case, the imaging controller 40 may display information on the parameters before and after the change next to each other on the display section 42 or the like.

In addition, the imaging controller 40 may change the imaging condition related to the radiation irradiation of the entire one imaging period according to the change content of the imaging condition. Specifically, the imaging controller 40 may change the imaging condition so as to reduce the total number of images to be captured from that before the change so that the total dose of the entire one imaging period does not increase. In addition, the imaging controller 40 may change the imaging condition so as to increase the total number of captured images from that before the change when the irradiation time or the like is decreased from that before the change.

In addition, the imaging controller 40 may adjust the imaging condition according to the changed content of the imaging condition. Specifically, the imaging controller 40 may adjust the imaging condition so that the smallest total number of images and the smallest total imaging time are obtained between the imaging condition before the change and the imaging condition after the change. As a result, even when the imaging condition is changed, the total dose does not increase, and thus it is possible to suppress an increase in the exposure dose due to the change in the imaging condition.

In addition, the imaging controller 40 may not change a part of the change targets of the imaging condition according to the change contents of the imaging condition. Specifically, when the change target in the imaging condition is the frame rate, the imaging controller 40 may not change the total number of captured images from that before the change. This is because the exposure dose does not change when the total number of captured images is the same.

Furthermore, the imaging controller 40 may change, according to the content of the change in the imaging condition, the waiting time at the time of restart of the imaging after the change in the imaging condition.

Further, the imaging controller 40 may change the imaging condition based on the consistency between the changed content of the imaging condition and the specific condition. Specifically, the imaging controller 40 may change the imaging condition only when a specific condition is satisfied at the time of changing the imaging condition.

For example, when the content of the change in the imaging condition is such that the dose is lower than that under the imaging condition before the change, the imaging controller 40 changes the imaging condition. When the change target of the imaging condition is the frame rate, the imaging controller 40 changes the imaging condition.

Furthermore, when the change target of the imaging condition is an operation related to a positioning change, the imaging controller 40 changes the imaging condition. In addition, the imaging controller 40 may not change the imaging condition when the change target of the imaging condition is a generation parameter of radiation (for example, a tube voltage, a tube current time product, or the like).

In addition, the imaging controller 40 may end the imaging of one imaging period when detection a specific positioning change operation and a geometrical change of irradiation. The specific positioning change operation may be, for example, an operation of changing the angle of the bulb by a relatively large amount. The irradiation field geometrical change may be, for example, a change such that the collimator is greatly opened or closed.

Further, the imaging controller 40 may change the imaging condition only when the change target of the imaging condition is a specific irradiation condition parameter. For example, the imaging controller 40 may not change the imaging condition when the specific irradiation condition parameter is the tube voltage, and may change the imaging condition when the specific irradiation condition parameters are the tube current, the irradiation time, and the tube current time product. Further, the imaging controller 40 may change the imaging condition when the specific irradiation condition parameter is the change of the additional filter.

Furthermore, when a parameter range different from a settable parameter range is set at the start of one imaging period, the imaging controller 40 may change imaging condition only for conditions within the different parameter range. For example, when the parameter range is narrower than the parameter range at the start, the imaging controller 40 may change the imaging condition.

Further, the imaging controller 40 may change the imaging condition when the total dose in one imaging period does not exceed the prescribed value due to the changed imaging condition. Further, the imaging controller 40 may change the imaging condition when the number of changes of the imaging condition is equal to or less than a predetermined number.

In addition, the imaging controller 40 may determine the end of imaging in one imaging period in a case in which the imaging condition is changed in the middle of one imaging period (during a non-irradiation period of radiation or the like). According to this, it is possible to suppress the total dose of the entire one imaging period from exceeding the prescribed value. Furthermore, in this case, after the end of imaging in one imaging period, the imaging controller 40 may set the changed imaging condition as the imaging condition for the next imaging period. Thus, it is possible to quickly shift to the next imaging period.

In a case where the imaging condition is changed in the middle of one imaging period (during a non-irradiation period of radiation or the like), the imaging controller 40 may continue imaging under the original imaging condition without changing the imaging condition. According to this, it is possible to suppress the total dose of the entire one imaging period from exceeding the prescribed value. However, since the imaging condition has not been changed, the imaging controller 40 may notify the user that the imaging condition has not been changed. A method of notifying the user includes changing a display color of a parameter operation button such as a tube voltage, a tube current, a tube current-time product, or an irradiation time.

In addition, during one imaging period, a setting or the like different from that at the start of imaging may be performed during a radiation non-irradiation period or the like.

For example, it is assumed that the filter is switched or removed. In this case, information indicating that the additional filter has been switched is input to the imaging controller 40 through a notification from the radiation emitting apparatus 30 or a selection operation by the radiologist. The imaging controller 40 applies the change to the setting of the imaging condition based on the input. That is, when an input indicating a predetermined change is made in the middle of one imaging period, the imaging controller 40 applies the predetermined change to the setting of the imaging condition.

In addition, in the non-irradiation period of radiation, an operation of reproducing the radiographic image of the intermittent imaging in which the imaging is ended may be performed. In this case, the imaging controller 40 may reproduce the radiographic image within the imaging period in accordance with the advance setting. Specifically, when the radiographic image can be reproduced within the imaging period, the imaging controller 40 may apply the reproduction operation, and when the radiographic image cannot be reproduced within the imaging period, the imaging controller 40 may not apply the reproduction operation.

Furthermore, when the radiographic imaging system 1 receives a notification that information about the battery 46 of the radiographic imaging system 1 is equal to or less than a certain value during a non-irradiation period of radiation, the imaging controller 40 may provide a notification to the user in accordance with the remaining capacity of the battery 46. For example, when the remaining charge of the battery 46 falls below a threshold value, there is a possibility that image capturing cannot be continued, and thus the image capturing controller 40 provides a notification to the user. Furthermore, for example, when it is set not to provide a notification to the user, the imaging controller 40 may not provide a notification to the user. Further, besides the information on the battery 46, for example, battery information of the FPD 20 may be notified to the user.

Furthermore, although control of the radiation emitting apparatus 30 and the like has not been particularly mentioned in the above-described embodiment, for example, various kinds of control may be changed according to the imaging mode and the like.

For example, at least one of the heating control of the filament and the control of the tube rotor may be performed by different control methods depending on the capturing of the still image, the capturing of the dynamic image in the normal imaging mode, and the capturing of the dynamic image in the intermittent imaging mode.

For example, the re-rotation control of the tube rotor is not performed in the capturing of the still image, but the re-rotation control may be performed in the capturing of the dynamic image in the normal imaging mode and the capturing of the dynamic image in the intermittent imaging mode. Further, although the re-rotation control of the tube rotor is not performed in the capturing of the still image and the capturing of the dynamic image in the normal imaging mode, the re-rotation control may be performed in the capturing of the dynamic image in the intermittent imaging mode.

Further, the rotation of the tube rotor and the heating of the filament may be continued immediately after the state of the radiographic imaging system 1 shifts to the non-irradiation period of radiation. Furthermore, when the non-irradiation period of radiation lasts for a relatively long time, the rotation of the tube rotor and the heating of the filament may be stopped.

In addition, the re-rotation control of the tube rotor and the heating control of the filament may not be periodically performed, but may be performed during the non-irradiation period of the radiation or when the non-irradiation period of the radiation is shifted to the irradiation period.

In addition, in the control of at least one of the dose area product (DAP), the calculation DAP, and the incident dose calculation, in the intermittent imaging mode, the value may be divided between the still image and the dynamic image, or the value may be acquired for each intermittent imaging. The calculation DAP obtains an area dose value by calculation instead of the area dosimeter.

In addition, in the control of at least one of the DAP, the calculation DAP, and the incident dose calculation, the control may be switched among the capturing of the still image, the capturing of the dynamic image in the normal imaging mode, and the capturing of the dynamic image in the intermittent imaging mode.

For example, the value is acquired in units of imaging in the imaging of the still image and the imaging of the dynamic image in the normal imaging mode, but the value may be acquired in units of intermittent imaging in the imaging of the dynamic image in the intermittent imaging mode.

In the above-described embodiment, each of capturing of a dynamic image and capturing of a still image is included at least once in the plurality of times of the capturing in the intermittent imaging mode. However, the present invention is not limited thereto. For example, the plurality of times of the imaging in the intermittent imaging mode may be only imaging of a dynamic image or may be only imaging of a still image.

In the above-described embodiment, the radiography control apparatus is the radiographic imaging system 1 including the radiographic imager (radiation emitting apparatus 30), but the present invention is not limited thereto. For example, a radiography control apparatus separate from the radiographic imager may be arranged in an operation room separate from the imaging room in which the radiographic imager is arranged.

In addition, each of the above-described embodiment is merely an example for embodying the present invention, and the technical scope of the present invention should not be interpreted in a limited manner by these embodiments. That is, the present invention can be implemented in various forms without departing from the spirit or main features thereof.

Although embodiments of the present invention have been described and illustrated in detail, the disclosed embodiments are made for purposes of illustration and example only and not limitation. The scope of the present invention should be interpreted by terms of the appended claims.

What is claimed is:

1. A radiography control apparatus that controls a radiographic imager capable of capturing a radiographic image by irradiation with radiation, the radiography control apparatus comprising:
a hardware processor that controls the radiographic imager in an intermittent imaging mode in which a plurality of times of capturing of a dynamic image by the radiographic imager are allowed during one imaging period from an imaging start to an imaging end, wherein
the hardware processor determines the imaging end in the one imaging period based on a predetermined condition.

2. The radiography control apparatus according to claim 1, wherein
the hardware processor determines an end of intermittent imaging in the intermittent imaging mode separately from a determination of the imaging end in the one imaging period.

3. The radiography control apparatus according to claim 1, wherein
the hardware processor variably controls a non-irradiation period of the radiation in the intermittent imaging mode according to an operation maintenance state on an operator of the radiographic imager.

4. The radiography control apparatus according to claim 1, wherein
the hardware processor variably controls an irradiation period of the radiation in the intermittent imaging mode according to an operation maintenance state on an operator of the radiographic imager.

5. The radiography control apparatus according to claim 1, wherein
when a non-irradiation period of the radiation in the intermittent imaging mode continues for a predetermined time, the hardware processor determines the imaging end in the one imaging period.

6. The radiography control apparatus according to claim 5, wherein
the hardware processor extends the predetermined time and continues the non-irradiation period of the radiation based on a specific operation.

7. The radiography control apparatus according to claim 1, wherein
the hardware processor determines the imaging end in the one imaging period in accordance with lapse of time during a non-irradiation period of the radiation subsequent to an irradiation period of the radiation in the intermittent imaging mode.

8. The radiography control apparatus according to claim 2, wherein
the hardware processor determines, based on a same operation, the end of the intermittent imaging in the intermittent imaging mode and the imaging end in the one imaging period.

9. The radiography control apparatus according to claim 2, wherein
after the intermittent imaging in the intermittent imaging mode ends, the hardware processor determines the imaging end in the one imaging period after acquiring a command to confirm an image during a period from the imaging start in the one imaging period to the end of the intermittent imaging, the image being captured by the radiographic imager.

10. The radiography control apparatus according to claim 1, wherein
when a predetermined operation is performed after the hardware processor acquires a command for the imaging end in the one imaging period, the hardware processor does not determine the imaging end and continues a non-irradiation period of the radiation in the intermittent imaging mode.

11. The radiography control apparatus according to claim 1, wherein
the hardware processor controls the radiographic imager such that each of capturing of the dynamic image and capturing of a still image is included at least once in the plurality of times of the capturing in the intermittent imaging mode.

12. The radiography control apparatus according to claim 1, wherein
in a case of capturing of a still image, the hardware processor determines an end of the capturing of the still image based on an irradiation time of the radiation regardless of an operation of an operator of the radiographic imager.

13. The radiography control apparatus according to claim 1, wherein
in a case of the capturing of the dynamic image, the hardware processor determines an end of the capturing of the dynamic image based on a number of frames of the dynamic image.

14. The radiography control apparatus according to claim 2, wherein
when the hardware processor determines the imaging end in the one imaging period before determining the end of the intermittent imaging in the intermittent imaging mode, the hardware processor applies the determination of the imaging end in the one imaging period to end the capturing by the radiographic imager.

15. The radiography control apparatus according to claim 1, wherein
the hardware processor determines the imaging end in the one imaging period based on at least one of input information to an operator of the radiographic imager and information on the capturing performed within the one imaging period.

16. The radiography control apparatus according to claim 14, wherein
when the hardware processor determines the imaging end in the one imaging period before determining the end of the intermittent imaging in the intermittent imaging mode, the hardware processor ends the capturing by the radiographic imager without determining the end of the intermittent imaging.

17. The radiography control apparatus according to claim 1, wherein
the hardware processor determines the imaging end in the one imaging period based on an operation state of an operation button displayed on a display that is capable of displaying the radiographic image being captured in the intermittent imaging mode.

18. The radiography control apparatus according to claim 1, wherein
the intermittent imaging mode is an imaging mode in which an irradiation period of the radiation and a non-irradiation period of the radiation are alternately generated so that the irradiation period of the radiation occurs at least twice during the one imaging period, the irradiation period being a period during which capturing of at least one of the dynamic image and a still image is performed, the non-irradiation period being a period during which the capturing of the at least one is not performed.

19. The radiographic imaging system, comprising:
a radiographic imager; and
the radiography control apparatus according to claim 1.

20. A non-transitory computer-readable recording medium storing a program for a radiography control apparatus that controls a radiographic imager capable of capturing a radiographic image by irradiation with radiation,
the program causing a computer to perform processing comprising:
controlling the radiographic imager in an intermittent imaging mode in which a plurality of times of capturing of a dynamic image by the radiographic imager are allowed during one imaging period from an imaging start to an imaging end, and
determining the imaging end in the one imaging period based on a predetermined condition.
